(19) United States
(12) Patent Application Publication
(10) Pub. No.: US 2013/0309638 A1
(43) Pub. Date: Nov. 21, 2013

(54) Home-school Geography Curriculum, Game, and Study Aid

(71) Applicant: Tabby Luquette Self, Newmarket, NH (US)

(72) Inventor: Tabby Luquette Self, Newmarket, NH (US)

(21) Appl. No.: 13/892,393

(22) Filed: May 13, 2013

Related U.S. Application Data
(60) Provisional application No. 61/647,810, filed on May 16, 2012.

(51) Int. Cl. G09B 29/00

(52) U.S. Cl. CPC G09B 29/003
USPC 434/150

(57) ABSTRACT

A comprehensive geography curriculum, game, and study aid geared toward home-school environments. The invention includes (a) an oversized map surface playing area containing unlabeled, pictorial representations of geographical regions or geological features including, without limitation, Africa, Antarctica, Asia, Australia-Oceania, Canada, Europe, North America, South America, the United States, and/or significant geological world features; (b) a plurality of labeled tokens which cross-reference with aforementioned regions or features represented on the map surface playing area; (b) a plurality of question and answer cards pertaining to historical data and current events of aforementioned regions or features represented on the map surface playing area; and (c) a booklet containing advanced information pertaining to regions or features represented on the map surface playing area. The method of play is designed as a multi-level, multi-sensory process which enhances retention and engages students in active learning through an entertaining medium. It also fosters self-study and instructor independence.

### CROSS REFERENCE TO RELATED APPLICATIONS

Benefit claims to prior applications under 35 USC §119(e), this application claims the benefit of U.S. Provisional Application No. 61/647,810, filed on May 16, 2012.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Geography students are presented with an enormous amount of information which must be memorized. Most prior and existing geography products rely heavily on labeled maps or globes thus requiring passive rather than active learning. Particularly, home-school students require an active method for effectively learning such material while simultaneously fostering independence in a multi-level environment. Existing or prior art does not provide a comprehensive, multi-level curriculum that engages students in hands-on, interactive play to enhance and expedite retention, while simultaneously fostering self-study and instructor independence.

Unlike computer software, the oversized, unlabeled maps and sizable manipulatives of the product described herein engage learners through multi-sensory means, and the competitive rules of play make the game interactive and engaging with multiple players. The game can be played individually or with as many players as desired and is designed to be multi-level, all important criteria for home-schools. Several elements allow for self-study, and all aspects provide immediate, self-correction thus encouraging independence from the instructor, another important criterion for home-school environments.

Computer software can be comprehensive, but the small size and lack of multi-sensory components limit retention. Some geographical regions or geological features can appear trivial on a standard sized computer screen and minimize the relevance to the learner. Additionally, computer programs often present geographical information in varying scales and in non-congruous partitions due to limited screen area. Presenting large-scale information in this manner can create difficulties. Learners may be unable to grasp the larger world picture and understand how varying geographical components relate to one another. Furthermore, computer software is generally not interactive with multiple students simultaneously.

Popular, large-scale floor and wall maps are often labeled, relying on passive learning. They are not interactive and do no promote active retention. Board games are typically limiting in their information due to size or playing constraints and/or do not provide multi-level play or self-study.

### BRIEF SUMMARY OF THE INVENTION

The proposed system is comprehensive and targets the special needs of home-school environments. The design fosters independence from instructors and functions with multi-level students, allowing students of varying ages and abilities to play together. It also provides methods for self-study and immediate self-correction. Retention is enhanced through competition using visually stimulating and multi-sensory components.

The proposed system includes the following comprehensive geographic subject matter: Continents, bodies of water, and significant geological world features; US states and capitals, and significant associated facts; Canadian provinces/territories and capitals, and significant associated facts; nations and capitals, and significant associated facts; most dependent and partially recognized regions and capitals, and significant associated facts. Additionally, question and answer cards related to the geographical regions and geological features provide supplemental historical and current event information.

This product utilizes oversized maps (approximately 3′ by 3′ or 3′ by 4′) providing visual relevance to each identified region or feature. Solid, textured manipulatives require active placement on the identified region or feature represented on the map playing surface area, thus engaging multiple senses. The game can be played alone or with as many users as desired. The product's large scale ensures comprehensiveness and relevance. The components are designed for three primary levels, novice, intermediate, and advanced, with varying sublevels of difficulties within each primary level.

### BRIEF DESCRIPTION OF THE SEVERAL VIEWS OF THE DRAWING

FIG. 1 depicts the map surface playing area composed of an oversized, roll-out map, approximately 3′ by 3′ or 3′ by 4′. Said map reflects pictorial representations of geographical regions and/or geological features. Each region or feature is coded with a specific map cross-reference number that coincides with a region or feature token, also containing the corresponding map cross-reference number. Located on the map surface playing area is the score tracker on which players move game piece markers to track accumulated points throughout game play.

FIG. 2 represents the container in which tokens are kept and from which tokens are drawn. Each token contains regional or feature identifying information on the front side. Additional regional or feature information, such as the capital or significant data, is located on the back side of the token along with a textured ridge. The textured ridge allows players to identify the front and back sides of the tokens through touch when tokens are drawn from the container. The ridge also indicates token level (novice, intermediate, or advanced) as well as token points through the use of various color codes. Located on the bottom of each token is the region or feature's map cross-reference number.

FIG. 3 is a booklet containing advanced information relating to each region or feature identified on the map playing surface area. Said booklet is designed to flip along a spiral binding to easily retrieve and reveal regional or feature information. The booklet may contain categorical information such as, without limitation, population, currency, primary religion(s), primary language(s), government type, or other geographical statistics or data.

FIG. 4 represents a stack of question and answer cards from which players draw cards as instructed on the score tracker. These cards contain questions with three levels of difficulty, novice, intermediate, and advanced. Answers to questions are located on the opposing side of the cards.

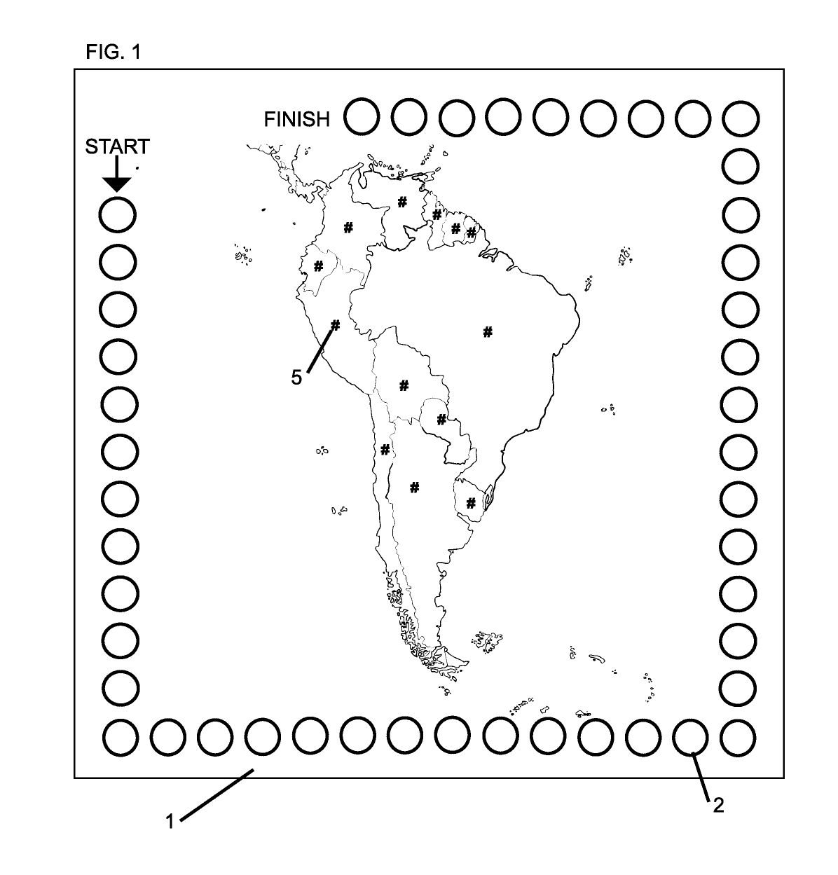

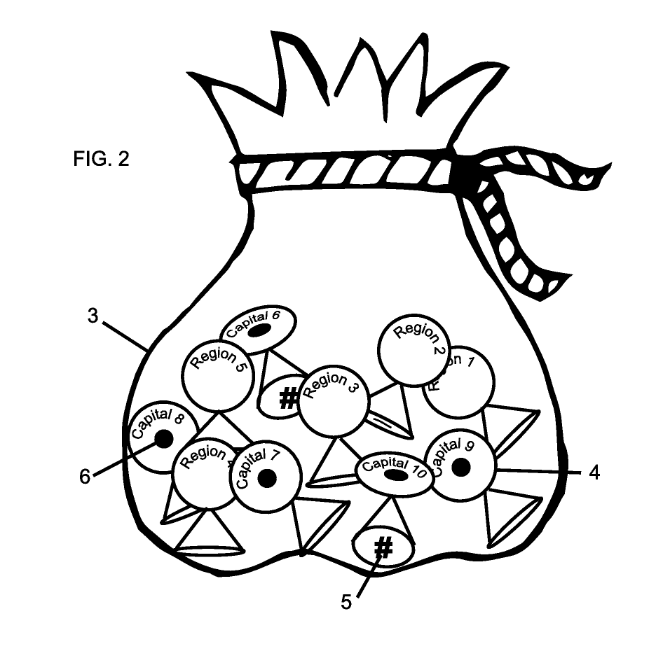

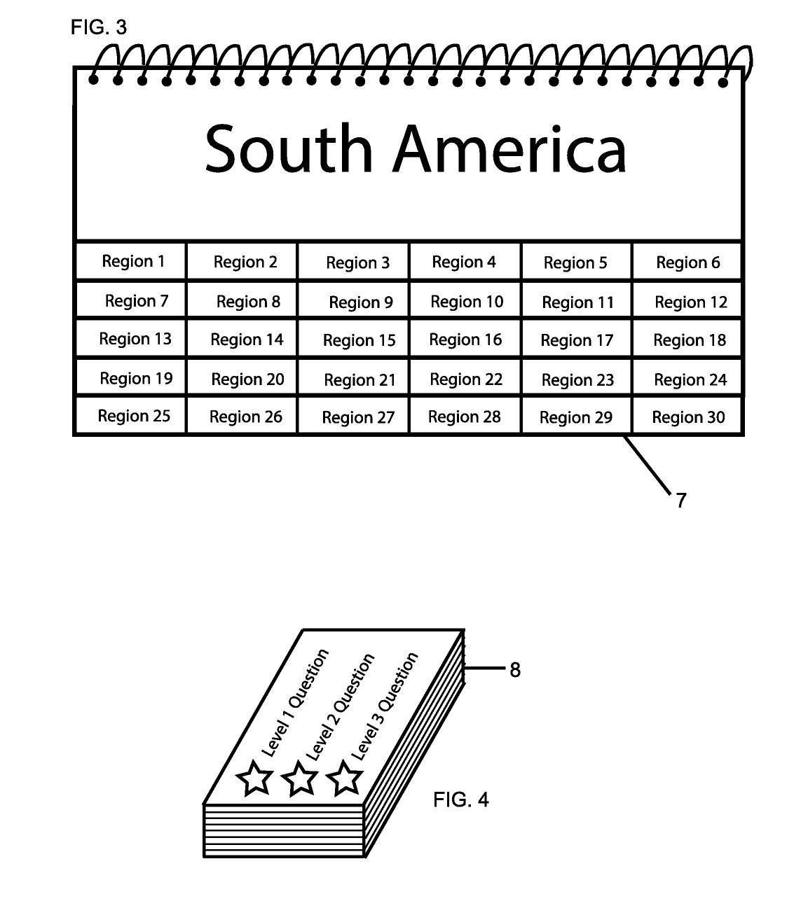

### DETAILED DESCRIPTION OF THE INVENTION

Components of the invention include: (1) map surface playing area, (2) tokens, (3) container, (4) booklet, (5) question and answer cards, (6) score tracker, (7) game piece markers, and (8) progression tracker.

The map surface playing area contains pictorial representations of geographical regions and/or geological features with each region or feature containing a map cross-reference number. A plurality of tokens, containing identifying region or geological feature information, corresponding map cross-reference numbers, and points, are individually drawn from the container during game play or for self-study. The supplemental booklet is used to enhance play level difficulty and for self-study. The question and answer cards provide supplemental historical and current event information related to regions and/or features represented on the map and are utilized during game play or for self-study. The game piece markers and score tracker, located on the map surface playing, are used to track players' scores as points are accumulated during game play.

Alternate rules may apply if the game is played individually or with multiple players, or if the product is used as a study aid rather than a competitive game. Alternate rules may also apply when players provide correct or incorrect responses or for varying individual and game levels of difficulty.

The invention contains seven, over-sized map surface playing areas containing pictorial representations of the following geographical regions, related sub-regions, and/or geological features: Africa, Antarctica, Asia, Australia-Oceania, Canada, Europe, North America, South America, the United States, continents, and world geological features. Each identifiable region or feature on the playing surface is distinctly colored and numbered with a map cross-reference number that corresponds with a distinct region or feature token.

A plurality of tokens contains regional or feature identification on the front side while the back side of the tokens contains additional information related to the region or feature identified on the front side. Such additional regional or feature information may contain, but is not limited to, capitals, dependency, and/or other significant related data. Said tokens also contain the corresponding map cross-reference number on the bottom. The back side of the tokens contains a textured ridge which allows identification of front and back through touch. Points adjust for difficulty as indicated by the color of the textured ridge located on the back side. The tokens are kept in a container during game play or for self-study and are individually drawn as play alternates between players or as students quiz themselves during self-study.

The invention also contains a plurality of question and answer cards which are set aside in a stack for drawing during game play. The invention includes a plurality of game piece markers, from which each player must choose a game piece before play commences. Players must determine the game level of play before play begins, as well as each player's individual token level of difficulty and each player's individual question and answer card level of difficulty.

To begin using the proposed invention, the player(s) must first determine if they are playing a multi-player game, an individual game, or simply using the product as a study aid.

To begin a multi-player game, the players must agree upon the game level of difficulty that will be used throughout the game. The appropriate tokens are selected according to the game level of difficulty and placed in the container. Each individual player then must determine an individual token level of difficulty and a question and answer card level of difficulty. Each individual's progression tracker may be referenced to determine the individual's current level of play. Each player must choose a game piece to be placed on the score tracker start position. The map surface playing area is rolled out onto a hard surface. The youngest player draws a single token from the container following instructions for the individual's token level of difficulty. The player attempts to place the token on the correct map region or feature that matches the region or feature identified on the drawn token. The player immediately checks the token placement using the map cross-reference number located on the map playing surface and on the bottom of the drawn token. If the answer is correct, the token remains on the map playing surface area, and the individual player moves his/her game piece on the score tracker the appropriate number of points as indicated on the drawn token.

The score tracker may instruct the player to draw a question and answer card or take another turn. If instructed to draw a question and answer card, a designated card reader reads a question aloud from the top drawn card. The question must coincide with the individual player's question and answer card level of difficulty. If an incorrect answer is furnished, the token is returned to the container, and play moves to the next player in a clockwise rotation. If a correct response is provided, the player moves his/her game piece the appropriate number of spaces on the score tracker according to game instructions. Play then moves to the next player in a clockwise rotation.

The game play process repeats until a player reaches the score tracker finish position or all tokens are exhausted from the container. The player to reach the finish position first is the winner. In the event all tokens are exhausted from the container before a player reaches the finish position, the player closest to the finish position is the winner.

In addition to tokens which specifically identify a region or feature, special tokens may be included. Special tokens contain instructions for the player who draws the token, such as, without limitation, “double points” or “extra try.” In the event a special token is drawn, the player may choose to use the token during his/her turn or hold the token for later use during game play. Once the special token is used, it must be returned to the container.

The invention is designed to ensure multi-level play. This is an important criterion in home-schools because oftentimes home-school environments include children with a wide variety of ages and abilities. If any one player is consistently winning games, that player's individual token level of difficulty and/or question and answer card level of difficulty is adjusted. The booklet can be used to further enhance an individual's level of difficulty. All players, regardless of age or ability, should be winning games periodically. Players' individual level of difficulty can be tracked using the progression tracker.

If playing a game as a single player, the individual must first determine the game level of difficulty. The appropriate tokens are selected according to the game level of difficulty and placed in the container. Special tokens and question and answer cards are removed and set aside and are not used during game play. The player must determine his/her individual token level of difficulty. The player's progression tracker may be referenced to determine the individual token level of play. The booklet may be used to add advanced levels of difficulty. The map surface playing area is rolled out onto a hard surface. The player draws a single token from the container following instructions for the individual's token level of difficulty. The player then attempts to place the token on the map playing surface area on the region or feature that corresponds with the drawn token. The player immediately checks correctness of token placement by comparing the map cross-reference numbers located on the bottom of the token and on the map region or feature chosen. If the incorrect region or feature was chosen, the token is placed on the correct region or feature, and said token remains on the map playing surface area. The player does not accumulate any points. If the player places the token on the correct region or feature, points are accumulated as indicated on the drawn token. Points are tracked using paper and pencil. Game play continues until all tokens in the container are exhausted. The objective of the game is to accumulate more points with each consecutive game played, an indication of geography retention.

The game is structured to advance students through a progression of curriculum difficulty levels using tokens, question and answer cards, and booklet. Each token is rated as novice, intermediate, or advanced, and each question and answer card contains three questions at the novice, intermediate, and advanced levels. The most novice players may use no question and answer cards. The booklet adds another layer of difficulty, if needed, consisting of regional or feature information related to categories such as, without limitation, population, primary language(s), primary religion(s), currency, government type, or other geographical statistics or data. Each student's current, individual playing level can be charted and easily referenced using the progression tracker.

The invention can also be used as a self-study aid. The student may use the tokens, supplemental booklet, and/or question and answer cards for self-quizzing. The student places tokens for desired study in the container and draws tokens singly from the container. While looking at one side, the student attempts to respond with the information located on the opposing side. The response is immediately checked by flipping the token to the opposing side. If the response is correct, the token is set aside. If the response is incorrect, the token is returned to the container. The question and answer cards and the supplemental booklet can be used similarly for self-quizzing.

All artwork, except for flags obtained from a publically available U.S. government website, may be designed by the inventor. Maps (approximately 3′ by 3′ or 3′ by 4′) containing the score tracker may be printed single or double sided using flexible, smudge and water-resistant, vinyl or canvas medium that can roll up. The tokens (approximately 1″ by 1.5″) may be purchased from a supplier, labeled with identifying information, and coated for durability. The container and game piece markers may be purchased from a supplier. The booklet may be printed on heavy weight paper, cut, laminated, and assembled with binding. The progression tracker may be printed on paper and included with the instruction insert. Modifications to the production process or to the design may fall within the spirit and scope of the invention as described herein.

The invention described herein is a comprehensive geography curriculum, designed as a multi-player game, individual game, or self-study aid and geared toward home-school environments. The design emphasizes interaction, competition, multi-level play, multi-sensory manipulation, and instructor independence. Modifications to the invention, such as, without limitation, changes to game rules, component structure, or geographical information, may fall within the spirit and scope of the invention as set forth in the following claims.

I claim:

1. A curriculum, game, and study aid comprising:
An oversized, roll-up map surface playing area printed with a score tracking system and pictorial representations of geographical regions and/or geological features, with each said region or feature marked with a map cross-reference number;
A plurality of tokens containing geographical information related to the geographical regions or geological features represented on the aforementioned map surface playing area;
A plurality of question and answer cards containing geographical information and significant current and historical event information related to the regions and/or features represented on the aforementioned map surface playing area;
A booklet containing advanced geographical information related to the regions and/or features represented on the aforementioned map surface playing area;
A plurality of markers used as game pieces for tracking players' scores;
A container for maintaining aforementioned tokens from which said tokens are drawn; and
A system for tracking individual players' inter-game and inter-study progression through various curriculum levels of difficulty.

2. The curriculum, game, and study aid of claim 1, wherein said map surface playing area, tokens, questions and answer cards, and booklet contain geographical information pertaining to Africa, Antarctica, Asia, Australia-Oceania, Canada, Europe, North America, South America, the United States, and/or world geological features.

3. The curriculum, game, and study aid of claim 1, wherein each said token contains a cross-reference number which matches the cross-reference number of a specific geographical region or geological feature located on the map surface playing area, where each said token contains a textured surface for front and back identification through touch, and said textured surface indicates points and difficulty level (novice, intermediate, or advanced) using varying color indicators.

4. The curriculum, game, and study aid of claim 1, wherein each question and answer card contains multiple questions designed for three levels of difficulty, novice, intermediate, and advanced.

5. The curriculum, game, and study aid of claim 1, wherein said booklet consists of geographical information related to the geographical regions and/or geological features indicated on the map surface playing area such as, without limitation, population, primary language(s), primary religion(s), government type, currency, or other geographical or geological statistics and data.

6. A method of playing a multi-player geography game, said method comprising:
Rolling out an oversized, roll-up map surface playing area, printed side up, and printed with a score tracking system and pictorial representations of geographical regions and/or geological features, with each said region or feature marked with a map cross-reference number;
Setting a plurality of question and answer cards, containing geographical information and significant current and historical event information related to the regions and/or features represented on the map surface playing area, in a stacked formation near the playing surface area with the question side facing upwards;
Each player selecting from a plurality of markers as a game piece and placing said markers on the score tracker start position located on the map surface playing area;
Choosing a game level of difficulty for all players throughout game play, selecting a plurality of tokens containing geographical information related to the regions or features located on the aforementioned map surface playing area, and placing said tokens into a container from which said tokens are maintained and drawn;
Referencing a progression tracker for each individual player to determine each individual's playing level of difficulty related to the aforementioned tokens and individual playing level of difficulty related to the aforementioned question and answers cards;
Adjusting individual levels of difficulties, as determined by the players, to ensure fair, competitive play among all players;
Utilizing a booklet containing advanced geographical information related to the regions and/or features represented on the map surface playing area to enhance individual levels of difficulty, if needed;
Starting with the youngest player, drawing a single token from the container and attempting to place said token on the map surface playing area on the region or feature which coincides with the region or feature identified on the drawn token;
Looking at the bottom of the drawn and placed token to check correctness of token placement on the map surface playing area by matching the cross-reference number located on the token bottom and the cross-reference number located on the region or feature chosen on the map surface playing area;
Replacing drawn token into container for incorrect token placement, or leaving token on map surface playing area for correct map placement;
Moving the player's game piece marker on the score tracker, located on the map surface playing area, for correct token placement and according to game instructions;
Drawing, reading, and responding to a question and answer card whenever indicated on the score tracker;
Replacing said drawn question and answer card to the bottom of the card stack once an answer is provided;
Moving the player's game piece marker on the score tracker, located on the map surface playing area, for correct question card answers and according to game instructions;
Alternating play, one player at a time, in a clockwise rotation;
Repeating game play until one player reaches the finish position of the score tracker or until all tokens in the container are exhausted;

7. The method according to claim 6, wherein said map surface playing area, tokens, questions and answer cards, and booklet contain geographical information pertaining to Africa, Antarctica, Asia, Australia-Oceania, Canada, Europe, North America, South America, the United States, and/or world geological features.

8. The method according to claim 6, wherein each question and answer card contains multiple questions designed for three levels of difficulty, novice, intermediate, and advanced.

9. The method according to claim 6, wherein each said token contains a cross-reference number which matches the cross reference number of a specific geographical region or geological feature located on the map surface playing area, where each said token contains a textured surface for front and back identification through touch, and said textured surface indicates points and difficulty level (novice, intermediate, or advanced) using varying color indicators.

10. The method according to claim 6, wherein a progression tracker contains a method for tracking players' individual inter-game progress, current playing level difficulty, and progress through the curriculum levels.

11. The method according to claim 6, wherein said booklet consists of geographical information related to the regions or features represented on the map surface playing area such as, without limitation, population, primary language(s), primary religion(s), government type, currency, or other geographical or geological statistics and data.

12. A method of playing an individual geography game, said method comprising:
Rolling out an oversized, roll-up map surface playing area, printed side up, and printed with a score tracking system and pictorial representations of geographical regions and/or geological features, with each said region or feature marked with a map cross-reference number;
Choosing a game level of difficulty for use throughout game play, choosing a plurality of tokens containing geographical information related to the regions or features represented on the aforementioned map surface playing area, and placing said tokens into a container from which said tokens are maintained and drawn;
Referencing a progression tracker for the player to determine his/her individual playing level of difficulty related to aforementioned tokens;
Utilizing a booklet containing advanced geographical information related to the regions and/or features represented on the map surface playing area to enhance individual level of difficulty, if needed;
Drawing a single token from the container and attempting to place said token on the map surface playing area on the region or feature which coincides with the region or feature identified on the token;
Looking at the bottom of the drawn and placed token to check correctness of token placement on the map surface playing area by matching the cross-reference number located on the token bottom and the cross-reference number located on the region or feature chosen on the map surface playing area;
Placing and leaving token on correct map region or feature for incorrect token placement, or leaving token on map surface playing area for correct token placement;
Accumulating points, as indicated on the token, for correct token placement using paper and pencil to track score;
Repeating play until tokens in the container are exhausted;
Comparing current final score to previous game scores to monitor progress.

13. The method according to claim 12, wherein said map surface playing area, tokens, and booklet contain geographical information pertaining to Africa, Antarctica, Asia, Australia-Oceania, Canada, Europe, North America, South America, the United States, and/or world geological features.

14. The method according to claim 12, wherein each said token contains a cross-reference number which matches the cross-reference number of a specific geographical region and/or geological feature located on the map surface playing area, where each said token contains a textured surface for front and back identification through touch, and said textured surface indicates points and difficulty level (novice, intermediate, or advanced) using varying color indicators.

15. The method according to claim 12, wherein a progression tracker contains a method for tracking players' individual inter-game progress, current playing level difficulty, and progress through the curriculum levels.

16. The method according to claim 12, wherein said booklet consists of geographical information related to the regions or features represented on the map surface playing area such as, without limitation, population, primary language(s), primary religion(s), government type, currency, or other geographical or geological statistics and data.

17. A method of individual self-study, said method comprising:
Referencing the individual's progression tracker to determine his/her current study level of difficulty;
Choosing a plurality of tokens, a plurality of question and answer cards, and/or a plurality of booklet geographical categories for desired study;
If chosen for study, selecting a plurality of tokens containing information related to geographical regions or geological features according to desired level of difficulty and placing said tokens into a container from which said tokens are maintained and drawn;
Drawing a single token from the container, and while looking at one side of said token, responding with the information located on the opposing side;
Checking correctness of response by flipping drawn token to opposing side;
Repeating process until tokens in the container are exhausted;
If chosen for study, placing a plurality of question and answer cards in a stack formation with the question side facing upwards;
Drawing the top question and answer card from the stack, and while looking at the question side of said card, responding with the correct answer located on the opposing side;
Checking correctness of response by flipping drawn card to the opposing side;
Returning card to the bottom of the card stack for incorrect responses, or setting aside card for correct responses;
Repeating process until all question and answer cards in the stack are exhausted;
If chosen for study, holding the booklet, containing a plurality of geographical categories, with region or feature tabs facing upwards and category information concealed;
Selecting a region or feature tab located on said booklet and responding with category information related to selected region or feature;
Checking correctness by flipping open booklet using corresponding region or feature tab;
Repeating process until all regions or features located on the booklet tabs are exhausted.

18. The method according to claim 17, wherein said tokens, question and answer cards, and booklet contain geographical information pertaining to Africa, Antarctica, Asia, Australia-Oceania, Canada, Europe, North America, South America, the United States, and/or world geological features.

19. The method according to claim 17, wherein a progression tracker contains a method for tracking players' individual inter-study progress, current study level difficulty, and progress through the curriculum levels.

20. The method according to claim 17, wherein each said token contains a textured surface for front and back identification through touch, and said textured surface indicates points and difficulty level (novice, intermediate, or advanced) using varying color indicators.

21. The method according to claim 17, wherein said question and answer cards contain multiple questions designed with three levels of difficulty (novice, intermediate, and advance) and contain geographical information and significant current and historical event information related to the regions and/or features indicated on the aforementioned tokens.

22. The method according to claim 17, wherein said booklet consists of tabs related to regions and/or features indicated the aforementioned tokens and contains geographical categories such as, without limitation, population, primary language(s), primary religion(s), government type, currency, or other geographical or geological statistics and data.
